(19) United States
(12) Patent Application Publication
(10) Pub. No.: US 2016/0268637 A1
(43) Pub. Date: Sep. 15, 2016

(54) ELECTROLYTE SOLUTION FOR LITHIUM ION SECONDARY BATTERIES AND LITHIUM ION SECONDARY BATTERY USING SAME

(71) Applicant: HITACHI, LTD., Chiyoda-ku, Tokyo (JP)

(72) Inventors: Shigetaka TSUBOUCHI, Tokyo (JP); Shohei SUZUKI, Tokyo (JP); Katsunori NISHIMURA, Tokyo (JP)

(73) Assignee: HITACHI, LTD., Tokyo (JP)

(21) Appl. No.: 15/028,308

(22) PCT Filed: Mar. 5, 2014
(86) PCT No.: PCT/JP2014/055541

§ 371 Date: Apr. 8, 2016

(51) Int. Cl. H01M 10/0569; H01M 4/587; H01M 10/0567; H01M 4/38; H01M 10/0525; H01M 10/0568

(52) U.S. Cl. CPC H01M 10/0569; H01M 10/0525; H01M 10/0568; H01M 10/0567; H01M 4/382; H01M 4/587; H01M 2004/027

(57) ABSTRACT

Provided are an electrolyte solution for lithium ion secondary batteries and a lithium ion secondary battery including the electrolyte solution for lithium ion secondary batteries, a positive electrode and a negative electrode. The electrolyte solution for lithium ion secondary batteries contains: an organic solvent containing a compound represented by formula (1); an electrolyte; and an additive containing metallic cations. In the formula (1), R¹, R² and R³ are independent of each other and are C₁-C₂ alkyl or C₁-C₂ alkoxyl. The metallic cations are of one or more types selected from K⁺, Rb⁺ and Cs⁺. One or more types of salt selected from a group consisting of KSO₃CF₃ and KN(SO₂CF₃)₂ can be cited as examples of the additive.

### TECHNICAL FIELD

The present invention relates to an electrolyte solution for lithium ion secondary batteries and a lithium ion secondary battery using the electrolyte solution.

### BACKGROUND ART

Nonaqueous electrolyte solutions having inflammability, made of a mixed solvent of chain carbonate and cyclic carbonate containing lithium hexafluorophosphate (LiPF₆) as the electrolyte salt, are used for many of electrolyte solutions for lithium ion secondary batteries. Because of their high output power and high energy density, the lithium ion secondary batteries are recently used for various applications as typified by automobiles, aircrafts and mobile devices. These applications are required to have a high level of safety, and accordingly, electrolyte solutions having flame retardance in the lithium ion secondary batteries are being demanded.

In that regard, phosphate is well known as a solvent having the flame retardance. Patent Document 1 discloses an electrolyte solution made by dissolving electrolyte salt in an organic solvent, characterized in that the organic solvent contains at least one type of phosphorus compound such as trimethyl phosphate.

### PRIOR ART DOCUMENT

### Patent Document

Patent Document 1: JP-1998-228928-A

### SUMMARY OF THE INVENTION

### Problem to be Solved by the Invention

In the case where the organic solvent contains a phosphorus compound such as trimethyl phosphate, there is a possibility in the charging process that the phosphorus compound is inserted between graphite layers of the negative electrode together with Li⁺, undergoes reductive decomposition, and cause a drop in the initial charging/discharging efficiency of the lithium ion secondary battery. The object of the present invention is to increase the initial charging/discharging efficiency of lithium ion secondary batteries.

### Means for Solving the Problem

Means for solving the above-described problem is as follows, for example:

An electrolyte solution for lithium ion secondary batteries, containing: an organic solvent containing a compound represented by formula (1); an electrolyte; and an additive containing metallic cations. In the formula (1), R², R² and R³ are independent of each other and are C₁-C₂ alkyl or C₁-C₂ alkoxyl. The metallic cations are of one or more types selected from K⁺, Rb⁺ and Cs⁺.

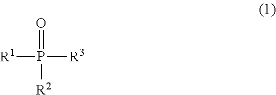

### Effect of the Invention

According to the present invention, an electrolyte solution for lithium ion secondary batteries capable of increasing the initial charging/discharging efficiency of the lithium ion secondary batteries can be provided. Other problems, configurations and effects will become apparent from the description of the following embodiments.

### BRIEF DESCRIPTION OF THE DRAWINGS

FIG. 1 schematically shows the internal structure of a lithium ion secondary battery.

### MODE FOR CARRYING OUT THE INVENTION

Referring now to the drawings, a description will be given in detail of preferred embodiments in accordance with the present invention. The following description will be given for illustrating specific examples of the contents of the present invention, and thus the present invention is not to be restricted to the description of those specific examples. A variety of modifications and corrections by those skilled in the art are possible within the scope of technical ideas disclosed in this description. Incidentally, elements having the same function are assigned the same reference character throughout the drawings for illustrating the present invention and repeated explanation thereof can be omitted for brevity.

### Lithium Ion Secondary Battery

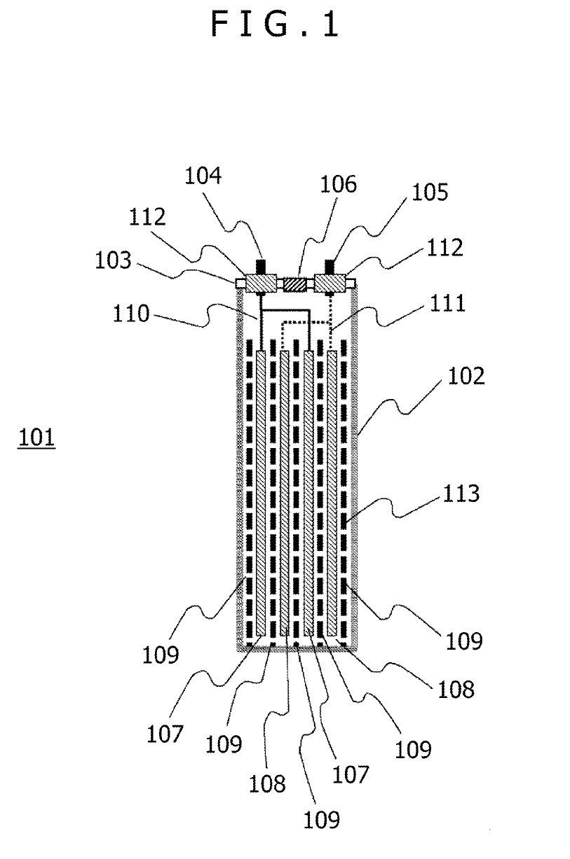

FIG. 1 schematically shows the internal structure of a lithium ion secondary battery 101. The lithium ion secondary battery 101 generically means an electrochemical device that enables the storage/use of electric energy by occlusion/discharge of ions into/from electrodes in a nonaqueous electrolyte. In this embodiment, the description will be given by taking a lithium ion secondary battery as a representative example of such an electrochemical device.

In the lithium ion secondary battery 101 shown in FIG. 1, an electrode set constituted of positive electrodes 107, negative electrodes 108 and separators 109 each inserted between positive and negative electrodes is stored in a battery case 102 in a hermetic state. The battery case 102 has a cover 103 on its top. The cover 103 has a positive electrode external terminal 104, a negative electrode external terminal 105 and a liquid injection port 106. After storing the electrode set in the battery case 102, the cover 103 is put on the battery case 102 and welded along its periphery to be integral with the battery case 102.

One or more positive electrodes 107 and one or more negative electrodes 108 are arranged alternately, and a separator 109 is inserted between adjoining positive and negative electrodes 107 and 108, by which the short circuit between the positive and negative electrodes 107 and 108 is prevented. The electrode set is constituted of the positive electrodes 107, the negative electrodes 108 and the separators 109. It is possible to use a polyolefin-based polymer sheet made of polyethylene, polypropylene, etc., a multilayer separator 109 made by welding polyolefin-based polymer onto a fluorine-based polymer sheet as typified by polytetrafluoroethylene, and so forth. A thin layer made of a mixture of a ceramic material and a binder may be formed on the surfaces of the separators 109 to prevent the separators 109 from contracting when the battery temperature rises. These separators 109 are required to allow through lithium ions when the lithium ion secondary battery 101 is charged or discharged. Thus, the separators 109 are usable for the lithium ion secondary battery 101 if their pore diameter is 0.01-10 μm and their porosity is 20-90%.

The separators 109 are inserted also between the battery case 102 and electrodes arranged at the ends of the electrode set in order to prevent the short-circuiting between positive and negative electrodes 107 and 108 via the battery case 102. An electrolyte solution 113 is held on the surfaces and in the pores of the separators 109, the positive electrodes 107 and the negative electrodes 108.

Upper parts of the electrode set are electrically connected to the external terminals via lead wires. Specifically, the positive electrodes 107 are connected to the positive electrode external terminal 104 via positive electrode lead wires 110, while the negative electrodes 108 are connected to the negative electrode external terminal 105 via negative electrode lead wires 111. Incidentally, the positive/negative electrode lead wire 110/111 may be formed in any desired shape such as a wire shape or a plate shape. The shapes and the materials of the positive and negative electrode lead wires 110 and 111 may be determined arbitrarily as long as the structure of the wires can achieve a low ohmic loss when electric current is fed through the structure and the materials of the wires do not react with the electrolyte solution 113.

Short-circuiting between the positive electrode external terminal 104 and the negative electrode external terminal 105 is prevented by inserting an insulating seal material 112 between the battery case 102 and the positive electrode external terminal 104 or the negative electrode external terminal 105. The insulating seal material 112 can be selected from various materials such as fluororesin, thermosetting resin and a glass hermetic seal. Any material not reacting with the electrolyte solution 113 and excelling in hermeticity is usable as the insulating seal material 112.

Arranging a current interruption mechanism employing a positive temperature coefficient (PTC) resistor element in the middle of the positive electrode lead wires 110, in the middle of the negative electrode lead wires 111, in a connection part between the positive electrode external terminal 104 and the positive electrode lead wires 110, or in a connection part between the negative electrode external terminal 105 and the negative electrode lead wires 111 makes it possible to stop the charging/discharging of the lithium ion secondary battery 101 and protect the battery when the internal temperature of the battery rises. Incidentally, the positive/negative electrode lead wires 110/111 may be formed in any desired shape such as a foil shape or a plate shape.

The structure of the electrode set may be in various forms, such as a stack of strip-shaped electrodes like the one shown in FIG. 1 or electrodes wound into a desired shape like a cylindrical shape or a flat shape. The shape of the battery case may be selected from various shapes such as a cylindrical shape, a flat elliptical shape and a rectangular shape to suit the shape of the electrode set.

The material of the battery case 102 is selected from materials having corrosion resistance to the nonaqueous electrolyte, such as aluminum, stainless steel and nickel-plated steel. In cases where the battery case 102 is electrically connected to the positive electrode lead wires 110 or the negative electrode lead wires 111, the material of the lead wires is selected such that corrosion of the battery case or transmutation of the material due to the alloying with lithium ions does not occur in parts in contact with the nonaqueous electrolyte.

Thereafter, the cover 103 is put in close contact with the battery case 102 and the whole battery is hermetically sealed. Examples of the method for hermetically sealing the battery include publicly known techniques such as welding and calking.

### Positive Electrode

The positive electrode 107 is formed of a positive electrode mixture layer and a positive electrode current collector. The positive electrode mixture layer is made of a positive electrode active material, mixed with a conductive agent and a binder as needed. Examples of the positive electrode active material include LiCoO₂, LiNiO₂, and LiMn₂O₄ as representative examples. Other examples of the positive electrode active material include LiMnO₃, LiMn₂O₃, LiMnO₂, Li₄Mn₅O₁₂, LiMn₂₋ₓMₓO₂ (M=Co, Ni, Fe, Cr, Zn, Ta, x=0.01-0.2), Li₂Mn₃MO₈ (M=Fe, Co, Ni, Cu, Zn), Li₁₋ₓAₓMn₂O₄ (A=Mg, Ba, B, Al, Fe, Co, Ni, Cr, Zn, Ca, x=0.01-0.1), LiNi₁₋ₓMₓO₂ (M=Co, Fe, Ga, x=0.01-0.2), LiFeO₂, Fe₂(SO₄)₃, LiCo₁₋ₓMₓO₂ (M=Ni, Fe, Mn, x=0.01-0.2), LiNi₁₋ₓMₓO₂ (M=Mn, Fe, Co, Al, Ga, Ca, Mg, x=0.01-0.2), Fe(MoO₄)₃, FeF₃, LiFePO₄, LiMnPO₄, and so forth. The positive electrode active material is not limited to these materials since the present invention is not restricted by the positive electrode material at all.

The particle diameter of the positive electrode active material is set to be within the thickness of the positive electrode mixture layer. In cases where the positive electrode active material powder contains coarse particles of sizes greater than or equal to the positive electrode mixture layer thickness, particles within the positive electrode mixture layer thickness are prepared by removing the coarse particles by means of sieve classification, airstream classification, or the like.

Since the positive electrode active material is powder, a binder for binding the particles of the powder together is necessary for forming the positive electrode active material into a positive electrode. In cases where the positive electrode active material is oxide, conductivity between the oxide particles is increased by adding carbon powder since conductivity of oxide is generally low.

The positive electrode active material, the conductive agent and the binder are blended together such that the mixture ratios (by weight percentage) of the positive electrode active material, the conductive agent and the binder are 80-95 wt. %, 3-15 wt. % and 1-10 wt. %, respectively. To achieve sufficient conductivity and to enable high-current charging/discharging, it is desirable to set the mixture ratio of the conductive agent higher than or equal to 5 wt. %. This is because the resistance of the whole positive electrode decreases and the ohmic loss can be suppressed even when high current is fed through the positive electrode. Conversely, to increase the energy density of the battery, it is desirable to set the mixture ratio of the positive electrode active material in a high range of 85-95 wt. %.

For the conductive agent, publicly known materials are usable, such as graphite, amorphous carbon, easily graphitizable carbon, carbon black such as Denka Black, activated charcoal, carbon fiber and carbon nanotubes. Examples of conductive fiber include vapor-grown carbon, fiber produced by high temperature carbonization of pitch (by-product of petroleum, coal, coal-tar, etc.) as the raw material, carbon fiber produced from acrylic fiber (polyacrylonitrile), and so forth. It is also possible to use fiber made of metallic material not oxidized or dissolved at the charging/discharging electric potential of the positive electrode (usually 2.5-4.3 V) and having lower electrical resistance than the positive electrode active material, such as corrosion-resistant metal like titanium or gold, carbide like SiC or WC, or nitride like Si₃N₄ or BN. As for the production method, existing production methods such as the melting method and chemical vapor deposition can be employed.

The positive electrode current collector is made by using aluminum foil 10-100 μm thick, perforated aluminum foil having a thickness of 10-100 μm and a pore diameter of 0.1-10 mm, expanded metal, a foam metal plate, or the like. As for the material of the positive electrode current collector, those other than aluminum, such as stainless steel and titanium, can also be employed. In the present invention, any type of current collector can be used with no restriction on the material, the shape, the production method, etc.

For the coating of the positive electrode 107, existing methods such as the doctor blade method, the dipping method and the spray method can be employed. There is no restriction on the means for the coating. For example, the positive electrode 107 can be produced by applying slurry on the current collector, thereafter drying the organic solvent, and pressure-molding the positive electrode by use of a roll press. It is also possible to stack a plurality of mixture layers on the current collector by performing the process from the coating to the drying multiple times.

### Negative Electrode

The negative electrode 108 is formed of a negative electrode mixture layer and a negative electrode current collector. The negative electrode mixture layer is mainly composed of a negative electrode active material and a binder. There are cases where a conductive agent is added as needed. The production method of the negative electrode will be explained below.

The negative electrode active material is carbon material having the graphene structure, for example. Specifically, it is possible to use carbonaceous materials capable of electrochemically occluding/discharging lithium ions such as natural graphite, artificial graphite, mesophase carbon, expanded graphite, carbon fiber, vapor deposition carbon fiber, pitch-based carbonaceous material, needle coke, petroleum coke, polyacrylonitrile-based carbon fiber and carbon black, or amorphous carbon materials synthesized by pyrolytically decomposing cyclic hydrocarbon of five-membered or six-membered rings or an oxygen-containing cyclic organic compound, for example. There are no problems in carrying out the present invention even by use of a mixed negative electrode made of materials like graphite, easily graphitizable carbon and hardly graphitizable carbon, or a mixed negative electrode or a composite negative electrode made of the aforementioned carbon material and the aforementioned metal or alloy. In the present invention, the negative electrode active material is not particularly limited; materials other than those mentioned above are also usable.

Conductive polymeric materials made of polyacene, polyparaphenylene, polyaniline and polyacetylene are also usable for the negative electrode 108. These materials may be combined with carbon materials having the graphene structure such as graphite, easily graphitizable carbon and hardly graphitizable carbon.

Negative electrode active materials usable in an embodiment of the present invention include aluminum, silicon and tin which can be alloyed with lithium. Further, carbonaceous materials made of graphite or amorphous carbon capable of electrochemically occluding/discharging lithium ions are also usable. The negative electrode active material in the present invention is not particularly limited; materials other than those mentioned above are also usable.

Slurry is prepared by adding a solvent to a mixture of the negative electrode active material produced as above and a binder according to an embodiment of the present invention and then having these materials kneaded or dispersed sufficiently. The solvent is organic solvent or water, for example. The material of the solvent may be selected arbitrarily as long as the material does not transmute the binder in the present invention.

The mixture ratio between the negative electrode active material and the binder is desired to be within the range of 80:20-99:1 by weight. To achieve sufficient conductivity and to enable high-current charging/discharging, it is desirable to set the above weight composition to make the ratio of the negative electrode active material lower than 99:1.

Conversely, to increase the energy density of the battery, it is desirable to blend the materials to make the ratio of the negative electrode active material higher than 90:10.

A conductive agent is added to the negative electrode as needed. For example, in cases where high-current charging or discharging is performed, it is desirable to lower the resistance of the negative electrodes by adding a small amount of conductive agent. For the conductive agent, publicly known materials are usable, such as graphite, amorphous carbon, easily graphitizable carbon, carbon black, activated charcoal, carbon fiber and carbon nanotubes. Examples of conductive fiber include vapor-grown carbon, fiber produced by high temperature carbonization of pitch (by-product of petroleum, coal, coal-tar, etc.) as the raw material, carbon fiber produced from acrylic fiber (polyacrylonitrile), and so forth.

The aforementioned slurry is applied to the negative electrode current collector and the solvent is dried by evaporation, by which the negative electrode 108 is produced. The negative electrode current collector is made by using copper foil 10-100 μm thick, perforated copper foil having a thickness of 10-100 μm and a pore diameter of 0.1-10 mm, expanded metal, foam metal plate, or the like. As for the material of the negative electrode current collector, those other than copper, such as stainless steel and titanium, can also be employed. In the present invention, any type of current collector can be used with no restriction on the material, the shape, the production method, etc.

For the coating of the negative electrode 108, existing methods such as the doctor blade method, the dipping method and the spray method can be employed. There is no restriction on the means for the coating. For example, the negative electrode 108 can be produced by applying the negative electrode slurry on the current collector, thereafter drying the solvent, and pressure-molding the negative electrode by use of a roll press. It is also possible to stack a plurality of negative electrode mixture layers on the current collector by performing the process from the coating to the drying multiple times.

### Electrolyte Solution

The electrolyte solution in an embodiment of the present invention contains an organic solvent, an electrolyte and an additive. The electrolyte solution may either consist exclusively of the organic solvent, the electrolyte and the additive or contain materials other than the organic solvent, the electrolyte or the additive.

### Organic Solvent

The organic solvent contains a flame-retardant solvent. A compound represented by the following formula (1) can be taken as a specific example of the flame-retardant solvent:

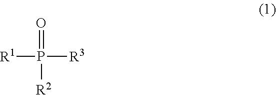

From the viewpoint of solubility of lithium salt, it is desirable in the compound represented by the formula (1) that R¹, R² and R³ are independent of each other and are C₁-C₂ alkyl or C₁-C₂ alkoxyl. From the viewpoint of not impairing the solubility of lithium salt and the flame-retardant function, it is desirable that at least two of R¹, R² and R³ are independent of each other and are C₁-C₂ alkoxyl, and it is more desirable that R¹, R² and R³ are methoxyl, or R¹ and R² are methoxyl and R³ is methyl. In the present invention, the “C₁-C₂ alkyl” and the “C₁-C₂ alkoxyl” mean unsubstituted groups.

As the compound represented by the formula (1), trimethyl phosphate (TMP) or dimethyl methylphosphonate (DMMP) is desirable, for example. The compound represented by the formula (1) has lower inflammability than one or more types of additional organic solvents which will be explained later. Thus, the compound represented by the formula (1) can be used as a flame retarder in the electrolyte solution for lithium ion secondary batteries according to the present invention. Further, the compound represented by the formula (1) has a higher donor number than the one or more types of additional organic solvents which will be explained later. Furthermore, the compound represented by the formula (1) has higher solubility of electrolyte than fluorine-based phosphorus compounds such as fluorine-containing phosphate ester. Thus, the compound represented by the formula (1) is capable of containing a desired amount of electrolyte dissolved therein even when the compound is used alone as the organic solvent without being mixed with another organic solvent.

The organic solvent may be used either in the form made exclusively of the compound represented by the formula (1) or in a form as a mixture of the compound represented by the formula (1) and one or more types of additional organic solvents (hereinafter referred to also as a “mixed solution”) as needed. In the case where the organic solvent is used in the form of a mixed solution, examples of the one or more types of additional organic solvents include: cyclic carbonate which is commonly used in this technical field, such as ethylene carbonate (EC) or propylene carbonate; chain (linear or branched) carbonate such as dimethyl carbonate, ethyl methyl carbonate (EMC) or diethyl carbonate; cyclic ether such as tetrahydrofuran or 1,3-dioxolane; chain (linear or branched) ether such as dimethoxyethane; cyclic ester such as γ-butyrolactone; and chain (linear or branched) ester such as methyl acetate or ethyl acetate. It is desirable to select the one or more types of additional organic solvents from a group consisting of ethylene carbonate (EC), ethyl methyl carbonate (EMC) and propylene carbonate. By using the one or more types of additional organic solvents, solubility of the electrolyte to the organic solvent can be increased.

The content of the compound represented by the formula (1) in the total volume of the organic solvent is preferably at least 10 volume %, more preferably at least 40 volume %, and still more preferably at least 50 volume %. Alternatively, the content of the compound represented by the formula (1) in the total volume of the organic solvent is preferably in the range of 10-100 volume %, more preferably in the range of 40-100 volume %, still more preferably in the range of 50-100 volume %, and especially preferably in the range of 50-60 volume %. If the content of the compound represented by the formula (1) in the organic solvent is in one of the above ranges, solubility of the electrolyte to the organic solvent can be increased.

### Electrolyte

In the electrolyte solution for lithium ion secondary batteries in an embodiment of the present invention, the electrolyte is desired to be one or more types of lithium salt selected from a group consisting of LiPF₆, LiBF₄, LiCF₃SO₃, LiN(SO₂F)₂, LiClO₄, LiCF₃CO₂, LiAsF₆ and LiSbF₆. Preferably, the electrolyte is LiPF₆. LiPF₆ is high in ionic conductance and also high in the solubility to the above-described organic solvent. Thus, by using LiPF₆ as the electrolyte, the battery characteristics (e.g., charging/discharging characteristics) of the lithium ion secondary battery obtained as the result can be improved.

In the electrolyte solution for lithium ion secondary batteries in an embodiment of the present invention, the electrolyte is desired to be contained at a concentration of at least 0.5 mol/L. The concentration is the mol concentration with respect to the total volume of the electrolyte solution. The concentration of the electrolyte is preferably in the range of 0.5-2 mol/L, more preferably in the range of 0.5-1.5 mol/L, and especially preferably in the range of 0.5-1 mol/L. By having the electrolyte solution contain the electrolyte at the concentration described above, the battery characteristics (e.g., charging/discharging characteristics) of the lithium ion secondary battery obtained as the result can be improved.

### Additive

K⁺, Rb⁺ and Cs⁺ can be cited as examples of metallic cations contained in the additive. From the viewpoint of ionization energy, K⁺, Rb⁺ and Cs⁺ are of lower Lewis acidity than Li⁺ and have no selectivity for solvation. The ion sizes of K⁺, Rb⁺ and Cs⁺ are larger than that of Li⁺, and consequently, only Li⁺ can engage in the insertion/elimination reactions into/from graphite. Since Li⁺ is solvated with cyclic carbonate such as EC and moves in the solution, the metallic cations such as K⁺ do not interact with these materials, which is desirable in that the effective number of Li⁺ ions is not reduced. Further, suppose K⁺ is solvated with EC and engages in the charging/discharging, this would cause a capacity drop or a decomposition reaction since K⁺ is larger than Li⁺ in the ion size. From K⁺, Rb⁺ and Cs⁺, either only one type or two more types may be selected and used as the metallic cations. In reality, the metallic cations have to be dissolved in the electrolyte solution as the additive, and thus Br—, I—, PF₆—, BF₄—, ClO₄—, SO₃CF₃—, N(SO₂F)₂—, N(SO₂CF₃)₂— and N(SO₂CF₂CF₃)₂— can be selected as counter anions of the metallic cations. From the viewpoint of solubility to the electrolyte solution, one or more types of salt selected from a group consisting of KN(SO₂CF₃)₂ and KSO₃CF₃ are desirable. The electrolyte solution may either contain only one type or more than one type of additive containing the metallic cations and anions described above.

In the electrolyte solution for lithium ion secondary batteries in an embodiment of the present invention, the additive is desired to be contained at a concentration of at least 0.05 mol/L. The concentration is the mol concentration with respect to the total volume of the electrolyte solution. The concentration of the additive is preferably in the range of 0.05-1 mol/L, and especially preferably in the range of 0.05-0.5 mol/L. By having the electrolyte solution contain the additive at a concentration in a range described above, formation of solvation molecules from lithium ions in the electrolyte and the compound represented by the formula (1) can be practically inhibited and the battery characteristics (e.g., charging/discharging characteristics) of the lithium ion secondary battery can be improved.

In the following, the present invention will be described more concretely by using some examples. The following description will be given of examples having features explained below and effects of the examples on the charging/discharging efficiency. In a battery configuration in which the working electrode is a graphite negative electrode and the counter electrode and the reference electrode are made of Li metal, constant-current charging was performed up to 0.01 V at a current value of 1 mA/cm², thereafter constant-voltage charging at 0.01 V was continued, the charging was ended when the current value converged at 0.025 mA/cm² or when seven hours elapsed, and discharging down to 1.5 V was performed at a current value of 1 mA/cm².

### Example 1

In a mixed solvent made of EC, EMC and TMP at a volume ratio of 16.7:33.3:50, LiPF₆ was dissolved at a concentration of 1.0 mol/L. To the solution, KN(SO₂CF₃)₂ was further dissolved as the additive at a concentration of 0.5 mol/L to complete the electrolyte solution. The result of evaluation of the initial charging/discharging efficiency in the electrolyte solution is shown in Table 1.

### Example 2

In a mixed solvent made of EC, EMC and TMP at a volume ratio of 16.7:33.3:50, LiPF₆ was dissolved at a concentration of 1.0 mol/L. To the solution, KSO₃CF₃ was further dissolved as the additive at a concentration of 0.5 mol/L to complete the electrolyte solution. The result of evaluation of the initial charging/discharging efficiency in the electrolyte solution is shown in Table 1.

### Comparative Example 1

In a mixed solvent made of EC, EMC and TMP at a volume ratio of 16.7:33.3:50, LiPF₆ was dissolved at a concentration of 1.0 mol/L to complete the electrolyte solution. The result of evaluation of the initial charging/discharging efficiency in the electrolyte solution is shown in Table 1.

### Example 3

In a mixed solvent made of EC, EMC and DMMP at a volume ratio of 16.7:33.3:50, LiPF₆ was dissolved at a concentration of 1.0 mol/L. To the solution, KSO₃CF₃ was further dissolved as the additive at a concentration of 0.5 mol/L to complete the electrolyte solution. The result of evaluation of the initial charging/discharging efficiency in the electrolyte solution is shown in Table 1.

### Comparative Example 2

In a mixed solvent made of EC, EMC and DMMP at a volume ratio of 16.7:33.3:50, LiPF₆ was dissolved at a concentration of 1.0 mol/L to complete the electrolyte solution. The result of evaluation of the initial charging/discharging efficiency in the electrolyte solution is shown in Table 1.

TABLE 1

| | | | | FLAME- | | | |
|---|---|---|---|---|---|---|---|
| | Li SALT | | | RETARDANT | | | INITIAL CHARGING/ |
| | (mol/dm⁻³) | SOLVENT | | SOLVENT | | LEWIS ACID | DISCHARGING |
| | LiPF₆ | EC | EMC | TMP | DMMP | SALT | EFFICIENCY (%) |
| EXAMPLE 1 | 1 | 16.7 | 33.3 | 50 | 0 | KN(SO₂CF₃)₂ | 90 |
| EXAMPLE 2 | 1 | 16.7 | 33.3 | 50 | 0 | KSO₃CF₃ | 79 |
| EXAMPLE 3 | 1 | 16.7 | 33.3 | 0 | 50 | KSO₃CF₃ | 49 |
| COMPARATIVE | 1 | 16.7 | 33.3 | 50 | 0 | NONE | 14 |
| EXAMPLE 1 | | | | | | | |
| COMPARATIVE | 1 | 16.7 | 33.3 | 0 | 50 | NONE | 22 |
| EXAMPLE 2 | | | | | | | |

From the examples 1 and 2 and the comparative example 1, it was confirmed that the efficiency increased from that of the electrolyte solution with no additive by mixing the additive KN(SO₂CF₃)₂ or KSO₃CF₃ of the present invention into the solution made by dissolving 1.0 mol/dm⁻³ of LiPF₆ in the mixed solvent of EC, EMC and TMP mixed at the volume ratio of 16.7:33.3:50.

From the example 3 and the comparative example 2, it was confirmed that the efficiency increased from that of the electrolyte solution with no additive by mixing the Lewis acid salt KSO₃CF₃ of the present invention into the solution made by dissolving 1.0 mol/L of LiPF₆ in the mixed solvent of EC, EMC and DMMP mixed at the volume ratio of 16.7:33.3:50. Further, it was clarified that the effect of the additive is achieved even when a flame retarder of a different type is used.

1. An electrolyte solution for lithium ion secondary batteries, containing:
an organic solvent containing a compound represented by a formula (1);
an electrolyte; and
an additive containing metallic cations, wherein:
R¹, R² and R³ in the formula (1) are independent of each other and are C₁-C₂ alkyl or C₁-C₂ alkoxyl, and
the metallic cations are of one or more types selected from K⁺, Rb⁺ and Cs⁺.

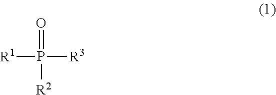

2. The electrolyte solution for lithium ion secondary batteries according to claim 1, wherein the electrolyte is LiPF₆.

3. The electrolyte solution for lithium ion secondary batteries according to claim 1, wherein the additive is one or more types of salt selected from a group consisting of KSO₃CF₃ and KN(SO₂CF₃)₂.

4. The electrolyte solution for lithium ion secondary batteries according to claim 1, wherein concentration of the additive is 0.05-1 mol/L.

5. The electrolyte solution for lithium ion secondary batteries according to claim 1, wherein at least two of R¹, R² and R³ are independent of each other and are C₁-C₂ alkoxyl.

6. The electrolyte solution for lithium ion secondary batteries according to claim 1, wherein R¹, R² and R³ are methoxyl, or R¹ and R² are methoxyl and R³ is methyl.

7. The electrolyte solution for lithium ion secondary batteries according to claim 1, wherein the organic solvent contains at least 50 volume % of the compound with respect to a total volume of the organic solvent.

8. A lithium ion secondary battery comprising:
an electrolyte solution for lithium ion secondary batteries according to claim 1;
a positive electrode; and
a negative electrode.
